(19) United States
(12) Patent Application Publication
(10) Pub. No.: US 2008/0047105 A1
(43) Pub. Date: Feb. 28, 2008

(54) Hinge unit

(75) Inventors: Jung-Wen Chang, Tao Yuan Shien (TW); Chun-Feng Lai, Sanchung City (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 11/583,170

(22) Filed: Oct. 19, 2006

(30) Foreign Application Priority Data
May 19, 2006 (TW) 95208720

(51) Int. Cl. E05D 11/06

(52) U.S. Cl. 16/374

(57) ABSTRACT

A hinge unit with double-side rotation function applicable on a computer device comprises a first support, a second support and a spindle wherein both of the supports has connecting portions at both ends to connect with the display unit and the base of the computer device. The hinge unit further comprises an angle limiter to limit the rotation angle.

### RELATED APPLICATIONS

The present application is based on, and claims priority from, Taiwan Application Serial Number 95208720, filed May 19, 2006, the disclosure of which is hereby incorporated by reference herein in its entirety.

### BACKGROUND

1. Field of Invention

The present invention relates to a hinge unit. More particularly, the present invention relates to hinge unit with a double-side rotation.

2. Description of Related Art

A convertible tablet PC (personal computer) integrates a normal notebook and tablet PC in a shell. FIG. 1 illustrates a schematic diagram of a conventional convertible tablet PC 100. From FIG. 1, the convertible table PC 100 includes a display unit 110, a base 130 and a hinge unit 120. If a user wants to convert the convertible table PC 100 from a notebook-like status to a tablet PC status, the user has to rotate the display unit 110 180 degrees and then push the display unit 110 to cover the base 130.

During the conversion, the display unit 110 can only be rotated in one direction, for example, as shown in FIG. 1, direction a is allowed for rotation while direction b is not. So, the user has to know the preset direction a or b for rotation before rotating the display unit 110 or the hinge unit 120 may get damaged easily.

### SUMMARY

It is therefore an aspect of the present invention to provide a hinge unit with double-side rotation. The hinge unit could be used on portable electronic devices such as a notebook or a tablet PC.

In order to achieve foregoing function, the hinge unit comprises a first support with a first hole, a second support with a second hole, and a spindle with a post crossing through the first hole and the second hole; wherein both of the first support and the second support has respective connecting portions on both ends to connect with a display unit and a base.

The hinge unit further comprises an angle limiter to limit the rotation angle. The ring-shaped angle limiter is set between the first support and the second support, and has an inner protrusion and an outer protrusion at the inner edge and the outer edge, respectively. The second support has a first stop and a second stop corresponding to the outer protrusion, thus while the spindle (or the post) is being rotated, the spindle (or the post) would bring the angle limiter to rotate together until the outer protrusion is stopped by the first stop or the second stop where the angle between the first stop and the second stop is the limited angle.

### BRIEF DESCRIPTION OF THE DRAWINGS

These and other features, aspects and advantages of the present invention will become better understood with regard to the following description, appended claims and accompanying drawings where:

FIG. 1 is a schematic diagram of a conventional convertible table PC;

FIG. 2 is an exploded view of a hinge unit in accordance with a preferred embodiment of the present invention; and

FIG. 3a˜3g show top views of a series of continuous operation diagrams of a hinge unit in accordance with a preferred embodiment of the present invention.

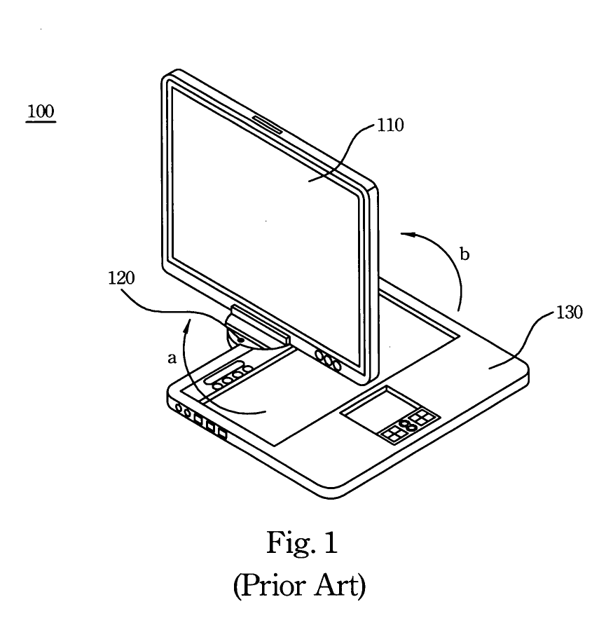

### DESCRIPTION OF THE PREFERRED EMBODIMENTS

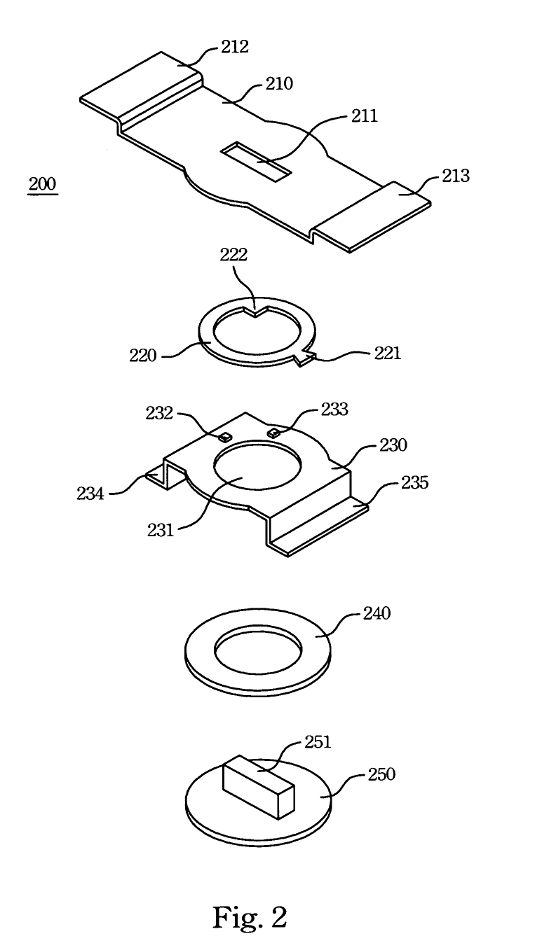

Refer to FIG. 2. FIG. 2 shows an exploded view of a hinge unit 200 in accordance with a preferred embodiment of the present invention. The hinge unit 200 is applicable on a portable computer device such as a notebook or a tablet PC to connect with both a display unit and a base (a host or a server) of the computer device and provide a double-side rotation function for the display unit wherein the display unit and the base are connected together electronically via the hinge unit. From FIG. 2, the hinge unit 200 comprises a first support 210 with a first hole 211, a second support 230 with a second hole 231 and a spindle 250. Both ends of the first support 210 has a first connecting portion 212 and a second connecting portion 213 used to connect with the display unit of the computer device; both ends of the second support 230 has a third connecting portion 234 and a fourth connecting portion 235 used to connect with the base of the computer device. The spindle 250 has a post 251 at one side crossing through an elastomer 240 (for example, a spring), the second hole 231 and the first hole 211 wherein the elastomer 240 provides the elasticity for the hinge unit 200.

The hinge unit 200 further comprises an angle limiter 220 to limit the rotation angle. The ring-shaped angle limiter 220 is set between the first support 210 and the second support 230; which disposes an inner protrusion 222 and an outer protrusion 221 at the inner edge and the outer edge, respectively. The second support 230 has a first stop 232 and a second stop 233 corresponding to the outer protrusion 221, thus while the spindle 250 is being rotated, the spindle 250 would bring the angle limiter 220 to rotate together until the outer protrusion 221 is stopped by the first stop 232 or the second stop 233 where the angle between the first stop 232 and the second stop 233 is the limited angle.

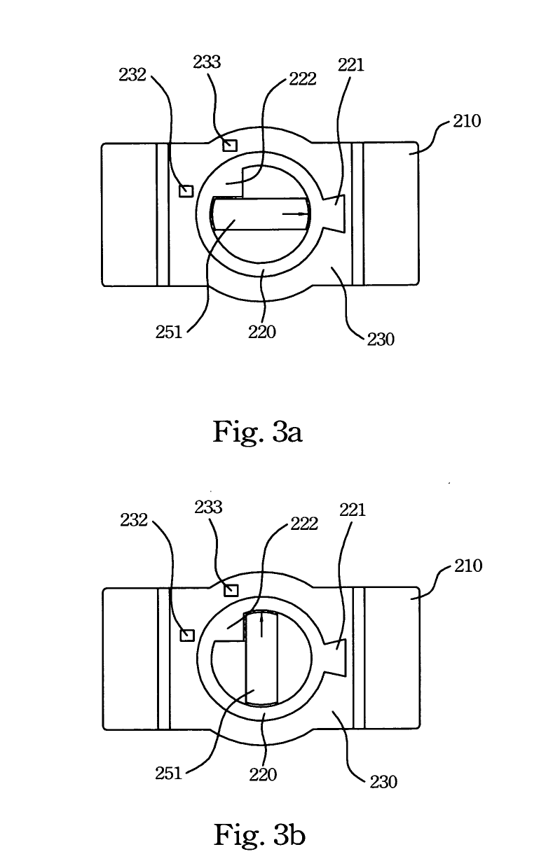

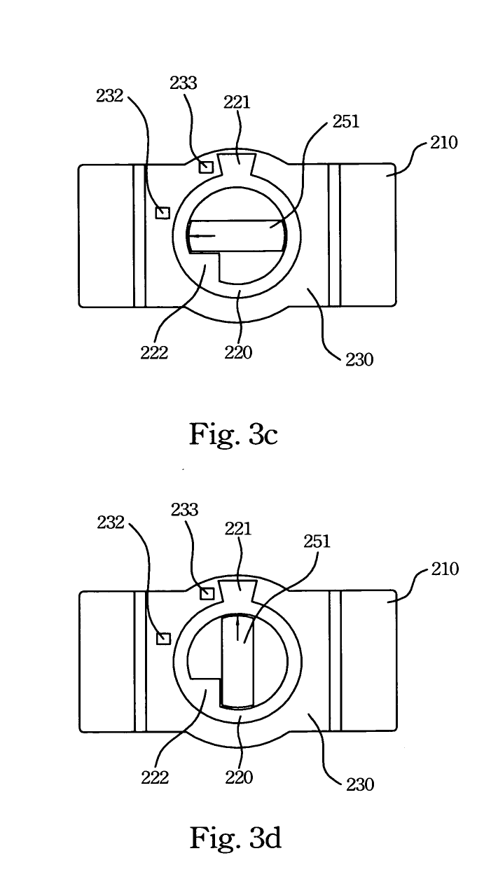

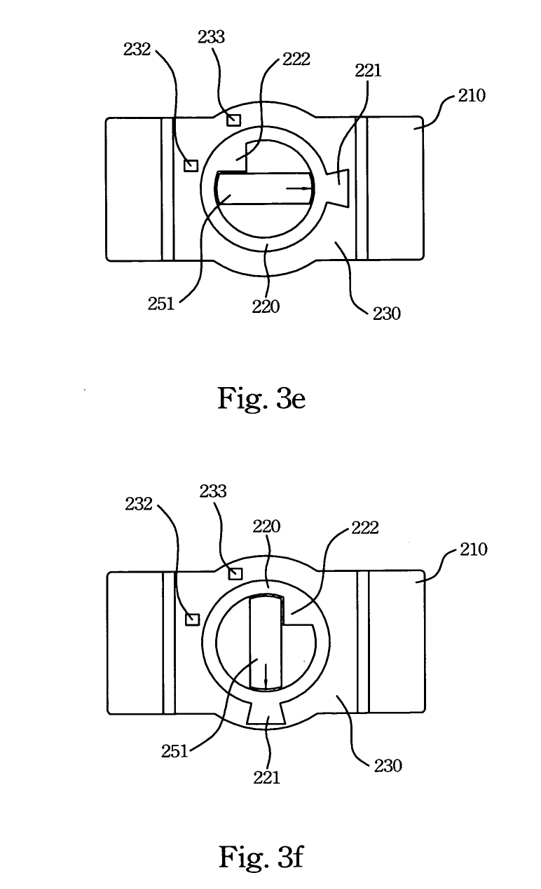

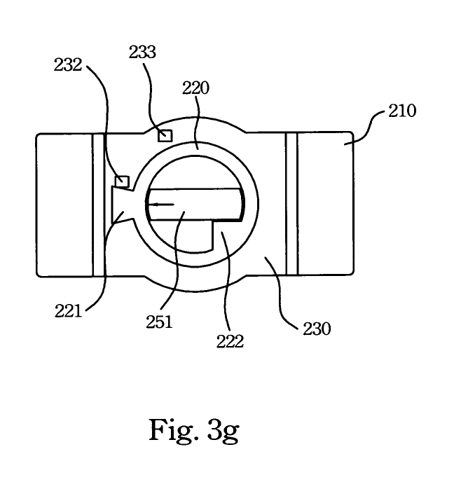

Refer to FIG. 3a˜3g FIG. 3a to FIG. 3g show the top views of a series of continuous operation diagrams of the hinge unit 200. The arrow in FIG. 3a˜3g is used to provide a better understanding of the invention. First, FIG. 3a shows the top view of the hinge unit 200 when the display unit is not rotated and the status is defined as 0 degrees (the post 251 of the spindle 250 points to right side) as shown in FIG. 3a. If the post 251 is rotated 90 degrees counterclockwise, the post 251 would touch the inner protrusion 222 of the angle limiter 220 as shown in FIG. 3b where the status is defined as 90 degrees (the post 251 points to the north side). At this time, if a user continues to rotate the post 251 counterclockwise, the angle limiter 220 would be pushed by the post 251 to rotate counterclockwise together as shown in FIG. 3c until the outer protrusion 221 touch the second stop 233 where the status is defined 180 degree (the post 251 points to left side). Due to the second stop 233 is fixed on the second support 230, the post 251 could not rotate counterclockwise anymore, and the limited angle of the counterclockwise rotation is 180 degrees.

From now on, rotate the post 251 clockwise, the post 251 would point from left side to north side as shown in FIG. 3c and FIG. 3d where the status is 90 degrees as defined (the post 251 points to north side) while the post 251 touches the inner protrusion 222 of the angle limiter 220 this time. Continue to rotate the post 251 90 degrees clockwise, the angle limiter 220 would be pushed by the post 251 to rotate clockwise together as shown in FIG. 3e where the status is 0 degrees as defined (the post 251 points t right side). Further continue to rotate the post 251 90 degrees clockwise, the post 251 would point from right side to south side, besides, and the angle limiter 200 still being pushed 90 degree clockwise together as shown in FIG. 3f where the status is defined as −90 degrees (the post 251 points to south side). Finally, still continue to rotate the post 251 90 degrees clockwise, the post 251 would point from the south side to left side and the angle limiter 200 is still being pushed 90 degrees clockwise by the post 251 together as shown in FIG. 3g where the status is defined −180 degrees (the post 251 points to left side). At this time, the outer protrusion 221 touches the first stop 232 which is fixed on the second support 230, so the post 251 could not be rotated clockwise anymore, and the limited angle of clockwise rotation is −180 degrees.

From the foregoing description, the invention uses a few members to provide the function of double-side rotation which not only overcomes the conventional problem of one side rotation leading to lower the probability of incorrect rotation but also easy to implement.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A hinge unit for connecting a display unit and a base, comprising:
a first support with a first hole;
a second support with a second hole; and
a spindle with a post crossing through the first support and the second support.

2. The hinge unit as claimed in claim 1, wherein the first support has a first connecting portion and a second connecting portion to connect with the display unit.

3. The hinge unit as claimed in claim 1, wherein the second support has a third connecting portion and a fourth connecting portion to connect with the base.

4. The hinge unit as claimed in claim 1, wherein the hinge unit further comprises an angle limiter set between the first support and the second support; and the angle limiter has an outer protrusion and an inner protrusion.

5. The hinge unit as claimed in claim 4, wherein the second support has a first stop and a second stop to stop the outer protrusion of the angle limiter where the angle between the first stop and the second stop is a limited angle.

6. The hinge unit as claimed in claim 5, wherein the limited angle accommodates rotation from 180 degrees to −180 degrees.

7. A computer device, comprising:
a display unit;
a base connected with the display electronically; and
a hinge unit for connecting the display unit and the base, comprising
a first support with a first hole;
a second support with a second hole; and
a spindle with a post crossing through the first support and the second support.

8. The computer device as claimed in claim 7, wherein the first support has a first connecting portion and a second connecting portion to connect with the display unit.

9. The computer device as claimed in claim 7, wherein the second support has a third connecting portion and a fourth connecting portion to connect with the base.

10. The computer device as claimed in claim 7, wherein the hinge unit further comprises an angle limiter set between the first support and the second support, and the angle limiter has an outer protrusion and an inner protrusion.

11. The computer device as claimed in claim 10, wherein the second support has a first stop and a second stop to stop the outer protrusion of the angle limiter where the angle between the first stop and the second stop is a limited angle.

12. The computer device as claimed in claim 11, wherein the limited angle accommodates rotations from 180 degrees to −180 degrees.
